(19) United States
(12) Patent Application Publication
(10) Pub. No.: US 2012/0278834 A1
(43) Pub. Date: Nov. 1, 2012

(54) APPARATUS, SYSTEMS, AND METHODS FOR DISCERNING USER ACTION WITH REGARD TO COMMERCIALS

(75) Inventor: Jon Richardson, Chamblee, GA (US)

(73) Assignee: ECHOSTAR TECHNOLOGIES L.L.C., Englewood, CO (US)

(21) Appl. No.: 13/095,661

(22) Filed: Apr. 27, 2011

(51) Int. Cl. H04N 7/025

(52) U.S. Cl. 725/34

(57) ABSTRACT

Systems and methods are described herein for altering the presentation of commercials presented based on user input of their likes and dislikes of commercials. A plurality of commercials are received and stored at a media device. A commercial user interface is presented with at least one commercial. A user selection associated with the presented commercial is received via the commercial user interface, wherein the user selection corresponds to one of a user dislike and a user like of the first commercial. Future presentation of at least one next commercial is altered based on the received user selection and the stored plurality of commercials.

### BACKGROUND

Current delivery of commercials is essentially a one-way transaction. The commercials are included in the broadcast media content. The viewer is presented with the commercials whether they are of interest or not. The only way for an advertiser to determine effectiveness of a commercial is to analyze information of typical viewers of the broadcast event associated with the commercial.

Accordingly, there exists a need to determine effectiveness or likeability of commercials, thereby improving the effectiveness of commercials.

### SUMMARY

Exemplary embodiments provide systems and methods for altering of commercials presented, based on user likes and dislikes of commercials. In an exemplary embodiment, a plurality of commercials are received and stored at a media device. A commercial user interface is presented with at least one commercial. A user selection associated with the presented commercial is received via the commercial user interface, wherein the user selection corresponds to one of a user dislike and a user like of the first commercial. Future presentation of at least one next commercial is altered based on the received user selection and the stored plurality of commercials.

In one aspect, the presentation of commercials in future commercial time slots is altered, based on user selection information.

In another aspect, the user selection information is saved and sent to a server device that will send updated commercials based on the received user selection information.

### BRIEF DESCRIPTION OF THE DRAWINGS

Preferred and alternative embodiments are described in detail below with reference to the following drawings:

FIG. 1 is a block diagram of an embodiment of a metadata system;

FIG. 2 is a block diagram of an embodiment of an exemplary media device;

FIG. 3 is a flowchart of an exemplary process performed by the systems shown in FIGS. 1 and 2; and

FIGS. 4 and 5 show screen shots of a user interface linked to a commercial, as provided by the systems shown in FIGS. 1 and 2.

### DETAILED DESCRIPTION

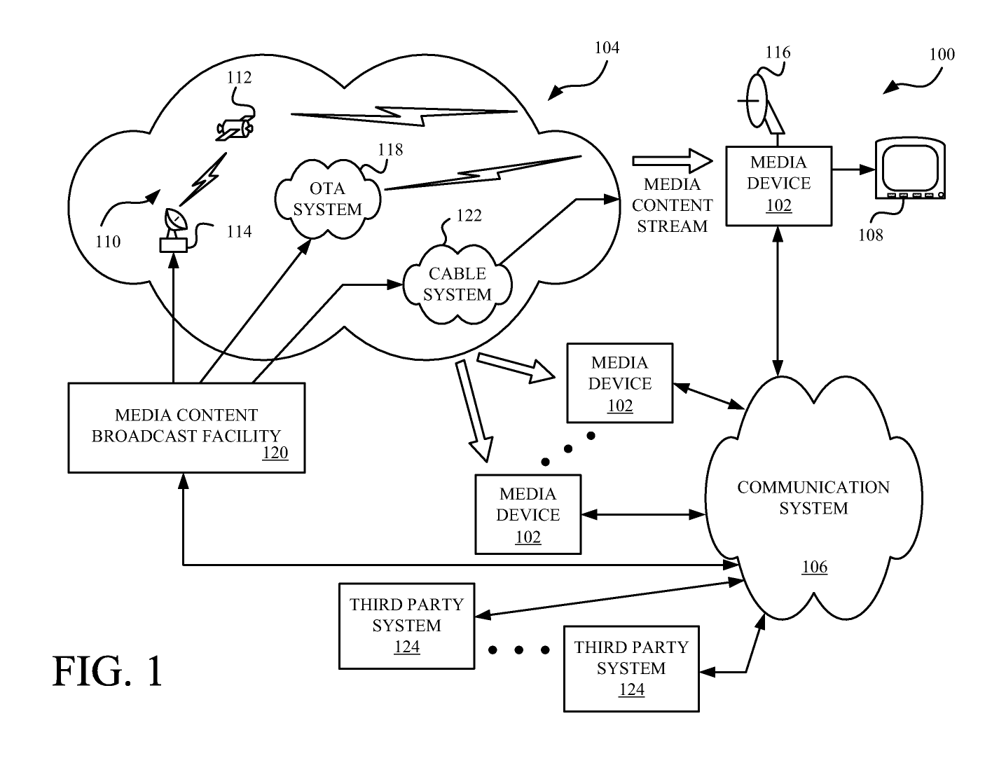

FIG. 1 is a block diagram of an embodiment of a commercial assessment system 100. The exemplary embodiment of the commercial assessment system 100 is implemented in an exemplary environment that includes a plurality of media devices 102, a broadcast system 104, and a communication system 106.

The media devices 102 are configured by a user to select one of the plurality of simultaneously broadcast media content events for presentation on a media presentation system 108. An exemplary media device 102 includes, but is not limited to, a set-top box (STB) that is communicatively coupled to the broadcast system 104. Other embodiments of the media device 102 include a television (TV), a digital video disc (DVD) player, a game-playing device, a personal computer (PC), a cellular phone, a portable media device, or a personal digital assistant (PDA). The media devices 102 present and/or store selected media content events and commercials that are included in the media content stream. Exemplary media presentation systems 108 include, but are not limited to, TVs, stereos, radios, surround-sound systems, personal computers, or the like that may be communicatively coupled to the media device 102. In some embodiments, the media device 102 and the media presentation system 108 may be a single integrated electronic media device, such as a PDA.

The media devices 102 may be identical to, or may be substantially similar to, other media devices 102. Or, the media devices 102 may be quite different from each other. Further, the media devices 102 may be coupled to different types of broadcast systems 104.

An exemplary broadcast system 104 includes a satellite broadcast system 110. One or more of the media content streams resides in a transport channel that is uplinked to a plurality of satellites 112, via a corresponding transmit antenna 114. The respective transport channels are then wirelessly communicated, from one or more of the satellites 112 to a receiver antenna 116 that is communicatively coupled to the media device 102. The received wireless signal (with the media content stream) is then communicated from the receiver antenna 116 to the media device 102. In one embodiment, the receiver antenna 116 and the media device 102 receive multiple wireless signals from a plurality of satellites 112.

Alternatively, or additionally, the plurality of media content events is broadcast to the media devices 102 via an over-the-air (OTA) system 118. For example, the media content broadcast facility 120 may be a local program provider that wirelessly broadcasts media content events to the media devices 102. The wireless signal with the media content stream is received at the receiver antenna 116, or is received directly by a receiver (not shown) residing in the media device 102.

Alternatively, or additionally, the plurality of media content events and a plurality of commercials are broadcast to the media devices 102 via a cable system 122. For example, the media content broadcast facility 120 may employ a coaxial cable, fiber optic cable, or comparable cable that is coupled to the media device 102 for transmitting the media content stream.

Alternatively, or additionally, the media device 102 may receive the media content event and commercials directly from a server device, such as the media content broadcast facility 120 or from another source over the communication system 106, via a communication (network) link. In an exemplary embodiment, the communication system 106 includes a public (the Internet) or private data network. The communication link between the media device 102 and the communication system 106 may be a dedicated communication link, such as an Ethernet communication link, a fiber optic communication link, a wireless link, a cable link, or the like. In some embodiments, the communication links may be established through the communication system 106, or may be established through a portion of the communication system 106.

Alternatively, or additionally, commercials may be sent to the media device 102 well prior to when a corresponding media content event is sent to the media device 102. These prior received commercials are stored in local memory and retrieved for playback at an appropriate time slot associated with the corresponding media content event.

The media content broadcast facility 120 is also in communication with one or more third-party systems 124. The media content broadcast facility 120 may transmit commercial time slot information or other program-related information to the third-party system 124 via the communication system 106.

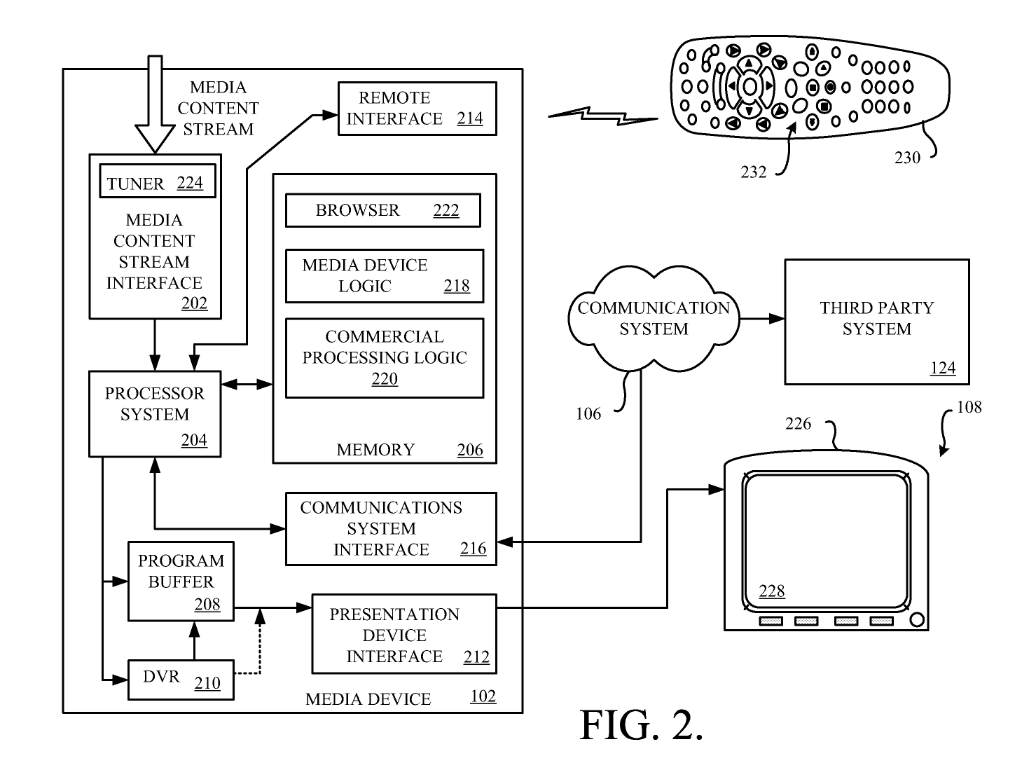

FIG. 2 is a block diagram of an embodiment of an exemplary media device 102. The nonlimiting exemplary media device 102 includes a media content stream interface 202, a processor system 204, a memory 206, a program buffer 208, an optional digital video recorder (DVR) 210, a presentation device interface 212, a remote interface 214, and an optional communication system interface 216. The memory 206 stores media device logic 218, commercial processing logic 220, and a browser 222. In one embodiment, some or all of these memory and other data manipulation functions may be provided by using a remote server or other electronic devices suitably connected, via the communication system 106 or otherwise, to the media device 102. Other media devices may include some, or may omit some, of the above-described media-processing components. Further, additional components not described herein may be included in alternative embodiments.

In an exemplary embodiment, the media content stream is received by the media content stream interface 202. One or more tuners 224 in the media content stream interface 202 selectively tune to a particular media content stream (i.e., media content event with commercials) in accordance with instructions received from the processor system 204. The processor system 204, executing the media device logic 218 and based upon a request for a program of interest specified by a user, parses out program content associated with the specified media content event. The media content event of interest with associated commercials is then assembled into a stream of video and/or audio information, which may be stored by the program buffer 208, such that the program content and commercials can be streamed out to the media presentation system 108, via the presentation device interface 212. Alternatively, or additionally, the parsed-out program content may be saved into the DVR 210 for later presentation. The DVR 210 may be directly provided in, locally connected to, or remotely connected to the media device 102. Alternatively, or additionally, the commercials are received prior to when they are to be streamed out to the media presentation system 108 and stored in the memory 206 until the media device logic 218 and the commercial processing logic 220 commands the processor system 204 to retrieve them.

In this embodiment, the presentation device interface 212 is illustrated as coupled to the media presentation system 108 that includes a visual display device 226, such as a television (hereafter, generically, a TV). Other types of presentation devices may also be coupled to the media device 102, including those providing any sort of stimuli sensible by a human being, such as temperature, vibration, and the like. The video portion of the streamed program content is displayed on a TV display 228 and the audio portion of the streamed program content is reproduced as sounds.

The exemplary media device 102 is configured to receive commands from a user via a remote control 230. The remote control 230 includes one or more controllers 232. The user, by actuating one or more of the controllers 232, causes the remote control 230 to generate and transmit commands, via a wireless signal, to the media device 102. The commands control the media device 102 and/or control the media presentation system 108. The wireless signal may be an infrared (IR) signal or a radio frequency (RF) signal.

The above processes performed by the media device 102 are generally implemented by the processor system 204 while executing the media device logic 218. Thus, the media device 102 may perform a variety of functions relating to the processing and presentation of the media content event.

The communication system interface 216 provides connectivity of the media device 102 to other remote devices (e.g., the third-party systems 124 and the media content broadcast facility 120) via the communication system 106. In an exemplary embodiment that is configured with Internet connectivity, the communication system interface 216 may be a suitable modem, or a device configured to connect to a modem. For example, the exemplary browser 222 may be used to access and/or retrieve the data from a remote site, such as a Web site. The accessed data may be searched, filtered, sorted, or otherwise processed at the media device 102. Additionally, or alternatively, the retrieved data may be stored by the media device 102, such as in the DVR 210, memory 206, or another suitable memory medium. Commercials received from the third-party system 124 or the media content broadcast facility 120 are stored in the memory 206. The communication system interface 216 may be any suitable device that is configured to provide connectivity of the media device 102 to the communication system 106.

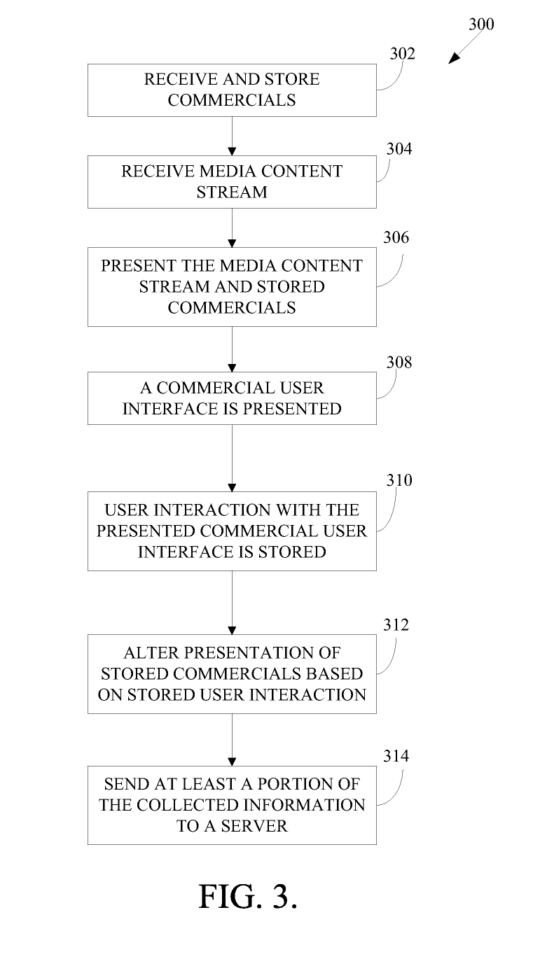

FIG. 3 illustrates an exemplary process 300 performed by the systems shown in FIGS. 1 and 2. First at a block 302, commercials are received at the media device 102 and stored within the memory 206 based on the commercial processing logic 220 previously stored in the memory 206. The commercials may be included in the received media content stream or are received from a server (e.g., the third-party system 124 or the media broadcast facility 120) via the communication system 106. If the commercials are received before they are to be presented in a previously assigned time slot within an associated media content event, then the commercials are stored in the memory 206. At a block 304, a media content stream is received at the media device 102. Next at a block 306, the media content stream and stored commercials are presented. In an exemplary embodiment, the commercials are presented based on the commercial processing logic 220 stored in the memory 206. The commercial processing logic 220 includes commercial selection logic that was included with the media content stream or received separately from a server device via the communication system 106. At a block 308, a commercial user interface generated by the commercial processing logic 220 is presented. The Commercial Processing Logic 220 decides when the commercial user interface should appear, e.g. when information received from the viewer on a particular commercial, product or topic is sparse, or when there is contradictory feedback. The Commercial Processing Logic 220 might also have a specified limit to how often it requests feedback, e.g. the commercial user interface is presented once per commercial break in order to not frustrate the viewer.

At a block 310, user interaction with the presented commercial user interface is received. The user interaction may be stored in the memory 206. Then at a block 312, presentation of the stored commercials is adjusted based on the received user interaction (i.e., the commercial selection logic is altered). For example, if the user interaction indicates that the user liked a particular beer ad, then the commercial selection logic is altered such that a similar beer ad (possibly an ad for the same product as in the previous ad) is requested to be presented in the following time slot. The alteration of the commercial selection logic may take on many forms. For example, the commercial selection logic may be altered to select ads produced by the same advertising agency that produced the previous ad. At a block 314, at least a portion of the collected information is sent to a server (e.g., the third-party system 124 or the media content broadcast facility 120) over the communication system 106.

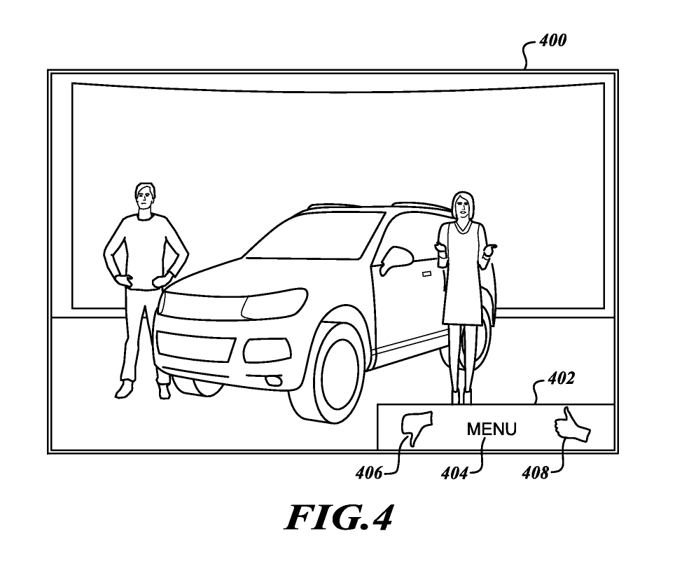

FIG. 4 is a screen shot 400 of a commercial that the processor system 204 has retrieved from the memory 206 or from the media content stream and presented on the display device 226, according to the commercial processing logic 220. Also, based on instructions provided by the commercial processing logic 220, a user interface 402 is presented in the lower-right corner of the display device 226, opaquely or transparently, over the presented commercial. The user interface 402 may be located at different locations of the display device 226 or may be presented on a display of the remote control 230. In an exemplary embodiment, the functions provided by the user interface 402 are linked to buttons of the controllers 232 of the remote control 230. The user interface 402 may be presented automatically when a commercial is presented or presented in response to a user's action (e.g., selection of a predesignated button of the controller). In an exemplary embodiment, the user interface 402 is automatically presented if the commercial processing logic 220 commands the presentation, based on one of a set flag in the media content stream or an instruction received from the third-party system 124 or the media content broadcast facility 120.

The user interface 402 includes a menu selectable 404 and thumbs-down selectable 406 and a thumbs-up selectable 408. If a user highlights or otherwise activates the thumbs-down selectable 406, the processor system 204 records in the memory 206 that the user dislikes the presented commercial. In an exemplary embodiment, the commercial processing logic 220 may alter the retrieval of one or more next presented commercials from the memory 206 for presentation into future commercial time slots in the media content stream based on the recorded dislike. For example, if the user indicates that they disliked a particular car ad, then the commercial selection logic is altered such that stored commercials that are similar (e.g., same product, same ad agency, similar product) are excluded from or given less likelihood of being presented in upcoming time slots. In an exemplary embodiment, the processor system 204 sends the recorded dislikes information to a server device (e.g., the third-party system 124) via the communication system 106.

If a user highlights or otherwise activates the thumbs-up selectable 408, the processor system 204 records in the memory 206 that the user likes the presented commercial. In an exemplary embodiment, the commercial processing logic 220 may alter the retrieval of one or more next presented commercials from the memory 206 for presentation into future commercial time slots in the media content stream based on the recorded like. For example, if the user indicates that they liked a particular beer ad, then the commercial selection logic is altered such that a similar beer ad (possibly an ad for the same product) is requested to be presented in one of the following time slots. In an exemplary embodiment, the processor system 204 sends the recorded likes information to the server device (e.g., the third-party system 124) via the communication system 106.

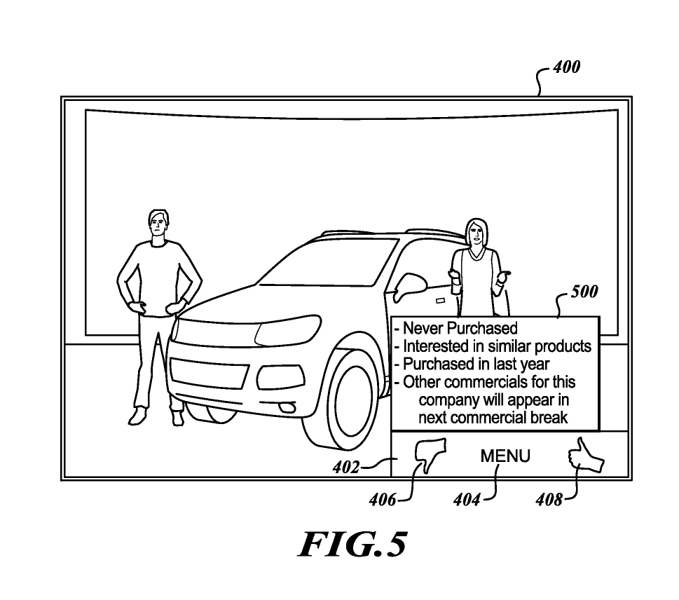

FIG. 5 illustrates a commercial menu 500 that is presented after the user has activated the menu selectable 404. The commercial menu 500 may include one or more queries related to the presented commercial. In an exemplary embodiment, the commercial menu 500 asks the viewer(s) if they've never purchased the product in the commercial, if they are interested in similar products, or if they have purchased the product in the commercial in the last year. Each of these queries is selectable by the viewer. If a selection is made, the selection is recorded in the memory 206. The processor system 204 sends any recorded query selections to a server (e.g., the third-party system 124 or the media content broadcast facility 120), according to the commercial processing logic 220.

The commercial menu 500 may also present information (nonselectable) relating to the presented commercial. As shown in FIG. 5, the commercial menu 500 indicates that there are other commercials, associated (part of a series) with the present commercial, that are scheduled to be presented in upcoming commercial breaks. For example, if the presented commercial is part of a storyline that is continued in additional commercials, the commercial menu 500 provides this information. Information of this type is previously received and stored prior to presentation. The commercial processing logic 220 instructs the processor system 204 to present this information for display if it is found in the memory 206.

The information associated with a currently viewed (e.g., currently presented) commercial may include information regarding one or more next presented commercials associated with the currently viewed commercial. The associated one or more next presented commercials are ones that are scheduled to be viewed in a later time slot for a currently associated media content event or the associated commercials could be selected for immediate viewing or for indicating dislike. Also, feedback that the viewer likes a particular group of commercials can be accepted.

In an exemplary embodiment, other user interactions with a presented commercial are recorded and used for determining presentation of commercials in later time slots. The analysis of these other user interactions is analyzed to infer a user like or user dislike of the commercial. One of the other user interactions includes skipping a commercial. The processor system 204 interprets a skip command generated by the user as a dislike for the commercial(s) being skipped. Another of the other user interactions includes fast forwarding through a commercial. The processor system 204 interprets a fast forwarding as a user dislike for the commercial(s) being fast forwarded. One other user interaction is rewinding to replay at least part of a commercial. The processor system 204 interprets a rewind action as a user like for the commercial being replayed.

In an exemplary embodiment, user commercial-viewing preference information is stored at a remote system (e.g., the media content broadcast facility 120 or the third party system 124). The system (e.g., the media content broadcast facility 120 or the third party system 124) delivers the commercials according to the stored user commercial-viewing preference information. For example, if the user's commercial-viewing preference information states a preference for longer, story-based commercials, then the system retrieves and delivers longer, story-based commercials to the media device 102.

Alternatively, or additionally, user commercial-viewing preference information is stored in the memory 206 of the media device 102. The processor system 204 retrieves commercials previously stored in the memory 206 according to the stored user commercial-viewing preference information.

It should be emphasized that the above-described embodiments of the system 100 are merely possible examples of implementations of the invention. Many variations and modifications may be made to the above-described embodiments. All such modifications and variations are intended to be included herein within the scope of this disclosure and protected by the following claims.

The invention claimed is:

1. A method performed by a media device, the method comprising:
receiving a plurality of commercials;
storing the plurality of commercials;
communicating a first commercial to a display that is configured to present the first commercial;
presenting a commercial user interface with the presented first commercial;
receiving a user selection associated with the presented first commercial via the commercial user interface, wherein the user selection corresponds to one of a user dislike and a user like of the first commercial; and
altering future presentation of at least one next commercial based on the received user selection and at least one of the stored plurality of commercials.

2. The method of claim 1, wherein receiving the user selection comprises:
receiving at least one of a first selection and a second selection from the presented commercial user interface, wherein the first selection indicates that the user likes the commercial, and wherein the second selection indicates that the user dislikes the commercial.

3. The method of claim 1, further comprising:
saving the received user selection; and
sending the received user selection to a server device via a communication system.

4. The method of claim 3, further comprising:
receiving the at least one next commercial from the server device after the received user selection was sent to the server device, wherein the received at least one next commercial is associated with at least one of the currently presented or a subsequently presented media content event; and
inserting the received at least one next commercial into a time slot for the associated currently or subsequently presented media content event.

5. The method of claim 1, further comprising:
presenting information associated with a currently viewed commercial.

6. The method of claim 5, wherein the presented information associated with a currently viewed commercial comprises information regarding commercials associated with the currently viewed commercial, the associated commercials being ones that are scheduled to be viewed in a later time slot for a currently associated media content event.

7. The method of claim 6, wherein the information regarding commercials associated with the currently viewed commercial is selectable for immediate viewing in response to a next user selection.

8. The method of claim 1, wherein receiving the user selection comprises:
receiving a user selection corresponding to information associated with user purchase information of a product identified in the presented commercial.

9. The method of claim 1, wherein receiving the user selection comprises:
receiving a user selection corresponding to information associated with user interest in at least one of a product identified in the presented commercial or in products similar to the product identified in the presented commercial.

10. The method of claim 9, wherein altering future presentation of a next commercial comprises:
retrieving at least one next commercial from the server device based on the user selection corresponding to information associated with user interest in products similar to a product identified in the presented commercial; and
inserting the retrieved at least one next commercial into a time slot for at least one of an associated currently or subsequently presented media content event.

11. A system comprising:
a tuner configured to receive a media content event and a plurality of commercials;
a memory device configured to store at least the received plurality of commercials;
a processor system communicatively coupled to the tuner and the memory, wherein the processor system is configured to present a commercial user interface simultaneously with a currently presented commercial; and
a remote interface communicatively coupled to the processor system, the remote interface configured to receive a user selection associated with the presented commercial user interface, and wherein the user selection corresponds to one of a user dislike and a user like of the currently presented commercial,
wherein the processor system selects one or more next commercials from the plurality of stored commercials based on the user dislike or the user like of the first commercial.

12. The system of claim 11, wherein the commercial user interface comprises:
a first selection interface configured to receive input indicating that the user likes the commercial; and
a second selection interface, configured to receive input indicating that the user dislikes the commercial.

13. The system of claim 11, wherein the processor system is further configured to:
save the received user selection; and
send the received user selection to a server device via a communication system.

14. The system of claim 13, wherein the processor system is further configured to:
receive at least one next commercial from the server device after the received user selection was sent to the server device, wherein the received at least one next commercial is associated with currently presented media content event; and
insert the received at least one next commercial into a time slot for the associated currently presented media content event.

15. The system of claim 11, wherein the processor system is further configured to present information associated with a currently viewed commercial.

16. The system of claim 15, wherein the presented information associated with a currently presented commercial comprises information regarding other commercials associated with the currently presented commercial, the associated other commercials being scheduled to be viewed in a later time slot for a currently associated media content event.

17. The system of claim 11, wherein the received user selection comprises a user selection corresponding to information associated with user purchase information of a product identified in the presented commercial.

18. The system of claim 11, wherein the received user selection comprises a user selection corresponding to information associated with user interest in at least one of a product identified in the presented commercial or in products similar to the product identified in the presented commercial.

19. The system of claim 18, wherein the processor system is further configured to:
retrieve at least one next commercial from a server device based on the user selection corresponding to information associated with user interest in products similar to a product identified in the presented commercial; and
insert the retrieved at least one next commercial into a time slot for at least one of an associated currently or subsequently presented media content event.

20. A method performed by a media device, the method comprising:
outputting at least one first commercial from a media device to a media presentation device for presentation;
receiving a user input regarding the first commercial at the media device during presentation by the media presentation device;
identifying at least one second commercial based on the received user input;
retrieving the at least one second commercial from memory of the media device; and
outputting the at least one second commercial to a media presentation device for presentation.
